(19) United States
(12) Patent Application Publication
(10) Pub. No.: US 2026/0119229 A1
(43) Pub. Date: Apr. 30, 2026

(54) MULTI-LEVEL OPTIMIZATION OF DATAFLOW GRAPH EXECUTION STRATEGIES

(71) Applicant: Hewlett Packard Enterprise Development LP, Spring, TX (US)

(72) Inventors: Alok Mishra, Edison, NJ (US); Marko Kabic, Zurich (CH); Rolando Pablo Hong Enriquez, Oxfordshire (GB); Dejan S. Milojicic, Palo Alto, CA (US)

(21) Appl. No.: 18/932,234

(22) Filed: Oct. 30, 2024

(51) Int. Cl. G06F 9/48; G06F 11/34

(52) U.S. Cl. CPC G06F 9/485; G06F 9/4881; G06F 11/3447

(57) ABSTRACT

According to an embodiment, a computer system for executing dataflow graphs in heterogeneous computing environments comprises a processor and memory storing instructions. The instructions cause the system to: receive a dataflow graph representing a computational task; access an implementation registry and hardware registry containing information on available operator implementations and computing hardware; access a cost model comprising execution and data transfer costs; generate an execution configuration for the dataflow graph by evaluating multiple configurations using a cost function considering execution and data transfer costs; and execute the task according to the generated configuration. The system utilizes a multi-level optimizer to generate optimal hybrid execution plans considering available hardware and implementation variants. This approach enables efficient execution of complex dataflows across heterogeneous computing resources.

### BACKGROUND

Dataflow engines process data through a series of operations represented as a graph. Each node in this graph corresponds to a specific operation, and edges represent the dataflow between operations. In modern computing environments, these operations can be executed on various hardware components such as CPUs, GPUs, and FPGAs.

Multiple implementation variants may exist for each operation in a dataflow graph. These variants can be optimized for different hardware or specific data characteristics. The choice of which implementation to use for each operation and decisions about data transfer between various hardware components can significantly affect the overall execution performance. As dataflow graphs become more complex and the variety of available hardware increases, finding the optimal execution strategy becomes increasingly challenging.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is an implementation of a dataflow graph with multiple implementation variants;

FIG. 2 is an implementation of a distributed grouped aggregation dataflow graph with data parallelism;

FIG. 3 is a simplified block diagram of a system for optimizing execution strategies in dataflow graphs;

FIG. 4 is an implementation of an execution graph demonstrating modular reconfigurability in dataflow optimization;

FIG. 5 is a block diagram of an example implementation registry;

FIG. 6 is a block diagram of an example hardware registry;

FIG. 7 is a block diagram of an example data transfer controller;

FIG. 8 is a block diagram of an example unified operators interface;

FIG. 9 is a flowchart of an implementation method for operating a multi-level optimizer circuit;

FIG. 10 is a flowchart of an implementation method for operating an implementation-aware optimizer circuit; and

FIG. 11 is a block diagram of an example computing device.

### DESCRIPTION

The following disclosure provides examples of implementing different features. Specific examples of components and arrangements are described below to simplify the present disclosure. These are, of course, merely examples and are not intended to be limiting.

The particular implementations are simply illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the inventive aspects are described primarily in the context of optimizing execution strategies for dataflow graphs in heterogeneous computing environments, it should also be appreciated that these inventive aspects may also apply to distributed dataflows. In particular, aspects of this disclosure may similarly apply to dataflows containing distributed operators involving communication between ranks in a distributed setting.

While the aspects described herein primarily focus on optimizing execution strategies for dataflow graphs in heterogeneous computing environments, they may also apply to various use cases, such as high-performance data analytics, extract, transform, load (ETL) workflows, and data processing workflows. These aspects may be particularly relevant to distributed dataflows, including those containing distributed operators that involve communication between ranks in a distributed setting. The optimization techniques and modular architecture can enhance performance and efficiency across a wide range of data-intensive applications, from complex analytical tasks to large-scale data transformation and processing operations.

The present disclosure relates to techniques for finding optimal execution strategies in dataflow graphs. In implementations, a system may extend standard dataflow engine architecture with additional components to enable hybrid execution strategies, considering available hardware and implementations. A multi-level optimizer can form the core of the system, comprising several layers, such as a logical optimizer for hardware-agnostic optimizations, a physical optimizer for lower-level optimizations, an implementation-aware optimizer to select implementation variants for each operator, a hardware-aware optimizer for hardware-specific decisions, and an execution-aware optimizer that may consider dynamic execution state.

The system may introduce an implementation registry containing information about available implementations for each operator and a hardware registry with details on available compute and data transfer hardware. An operator pool can unify interfaces for operators and implementations, while a data transfer manager may handle data movement between devices. To find the optimal execution strategy, the system can formulate an Integer Linear Program (ILP) or, under certain conditions, a Linear Program (LP). These programs may minimize a cost function that accounts for computation and data transfer costs.

The proposed approach can allow for efficient execution of dataflow graphs in heterogeneous computing environments, adapting to different dataflow structures and hardware configurations. The system may handle local and distributed dataflows, with the latter involving communication operations between ranks in a distributed setting. The solution provided by solving the ILP or LP can determine which implementation variant to use for each operator in the dataflow graph, enabling optimized performance across various hardware components and implementation options. These and additional details are further detailed below.

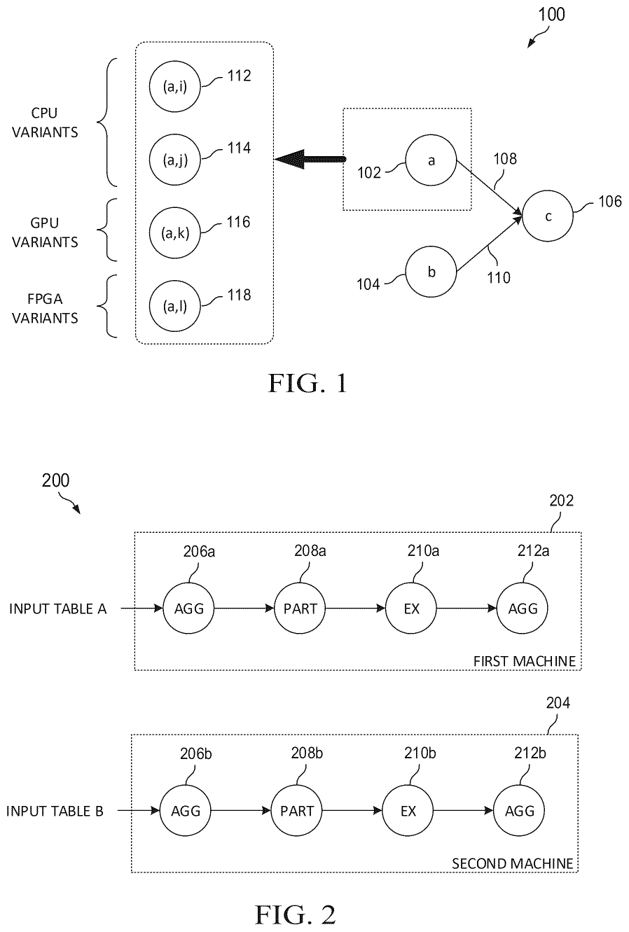

FIG. 1 illustrates an implementation of a dataflow graph 100 with multiple implementation variants. The dataflow graph 100 comprises three operators (or nodes): a first operator a 102, a second operator b 104, and a third operator c 106, which may (or may not) be arranged as shown. The dataflow graph 100 includes two directed edges: a first edge (a, c) 108 coupling the first operator a 102 to the third operator c 106 and a second edge (b, c) 110 coupling the second operator b 104 to the third operator c 106. It should be appreciated that the number of nodes and edges is non-limiting and may differ from that shown in dataflow graph 100.

Dataflow graph 100 exemplifies the concepts of implementation variants and backends in the context of a dataflow graph. It showcases how a single operator can have multiple implementations tailored for different hardware platforms, allowing an implementation system to select the most appropriate variant based on available resources and optimization goals. The flexibility enables the system to effectively utilize heterogeneous computing resources and adapt to various computational environments.

The dataflow graph 100 can be represented as a directed graph G=(V, E), where V denotes the set of nodes and E represents the set of edges. In this context, each node in set V corresponds to an operation or computation step. In contrast, the edges in set E indicate the dataflow between the operations. The graph structure allows for a clear visualization and representation of complex computational processes, showing how data moves and is transformed through various processing stages.

The directed nature of the graph implies that data flows in a specific direction, from one operation to the next, following the edges that connect the nodes. This representation enables system designers and optimizers to analyze the dependencies between operations, identify potential parallelism, and make informed decisions about resource allocation and execution strategies.

An operator involves (or can represent) communication operations. Local operators refer to operators that do not include any communication between ranks in a distributed setting. In contrast, distributed operators refer to operators that involve or represent communication between ranks in the distributed setting. An operator can be represented by a node in the dataflow graph. A distributed setting (or distributed dataflow) refers to any dataflow that contains at least one distributed operator. Generally, an operator can be mathematically understood as a function that performs a specific computation or transformation on its input data.

For example, the first operator a 102 and the third operator c 106 in the set V (i.e., a, c∈V) of the dataflow graph 100 are connected by the first edge (a, c) 108 in the set E (i.e., (a, c)∈E). This signifies that the output produced by operator a serves as the input for operator c. Accordingly, the relationship can define the dataflow through the graph, with each operator processing its inputs and passing the results to subsequent operators connected by outgoing edges.

The first operator a 102 demonstrates the concept of multiple available implementation variants. In this example, the variants are categorized into three groups based on the hardware they are optimized for: central processing units (CPUs), graphics processing units (GPUs), and field-programmable gate arrays (FPGAs) variants. It should be noted that the computing hardware may also include an application-specific integrated circuit (ASIC), a tensor processing unit (TPU), and a digital signal processor (DSP), in addition to or in lieu of the computing hardware types in FIG. 1.

For example, the CPU variants for the first operator a 102 are shown as a first variant (a, i) 122 and a second variant (a, j) 124. The GPU variant for the first operator a 102 is shown as a third variant (a, k) 126. The FPGA variant for the first operator a 102 is shown as a fourth variant (a, l) 128.

Implementation in the present disclosure refers to an operator implementation, as an operator can have multiple implementations, each designed to perform the same fundamental operation but optimized for different scenarios, hardware, or performance characteristics. For example, a sort operator may have various implementations, such as a CPU-Quick-Sort implementation, a CPU-Merge-Sort implementation, or a GPU-Bitonic-Merge-Sort implementation. The implementations can be designed for different hardware types, with some optimized for CPU execution and others for GPU execution.

Implementation variants refer to different implementations of the same operator. These variants allow the system to choose the most appropriate implementation based on the specific execution environment, data characteristics, and optimization goals.

Computation backends or backends refer to implementation variants on different computing hardware. These represent the different ways an operator can be executed on various hardware platforms, such as CPUs, GPUs, or FPGAs. Each backend can be tailored to leverage its target hardware's unique characteristics and capabilities, optimizing performance for that particular computational environment. By providing multiple backends for each operator, the system can effectively utilize heterogeneous computing resources, selecting the most appropriate implementation based on the available hardware and the specific requirements of the task at hand.

In FIG. 1, each implementation variant represents a distinct realization of the same operator (i.e., first operator a 102), optimized for specific hardware or performance characteristics. For example, the first variant (a, i) 122 and the second variant (a, j) 124 may represent different sorting algorithms optimized for CPU execution, while the third variant (a, k) 126 may be a GPU-specific implementation such as a bitonic sort.

The directed edges (i.e., first edge (a, c) 108 and the second edge (b, c) 110) indicate the flow of data from the first operator a 102 and the second operator b 104 to the third operator c 106. Depending on the chosen implementation variant for the first operator a 102, data transfer or transformation kernels may be necessary to ensure compatibility with the third operator c 106. These kernels can perform operations such as data copying between different memory locations or changing the data format to meet the requirements of the receiving operator.

A data transfer refers to an additional data processing task associated with an edge in the dataflow graph. A data transformation kernel performs necessary operations when data is passed from one operator to the next. These operations may include data transfer, such as copying data between different memory locations, or data transformation, which involves changing the data format or structure to meet the receiving operator's requirements.

The need for such kernels can become particularly advantageous when operators are connected by a directed edge that utilizes different backends. For example, if the first operator a 102 executes on a CPU and the third operator c 106 on a GPU, a data transfer kernel may be required to move the data from CPU memory to GPU memory. Similarly, if the output format of the first operator a 102 differs from the expected input format of the third operator c 106, a transformation kernel may be necessary to reconcile the differences.

Modern dataflow frameworks face multiple challenges as the volume and diversity of data to be processed continue to grow. Generally, this growth necessitates using heterogeneous computing hardware and various data transfer hardware like interconnects and links. Further, the diversity of algorithms and applications optimized for different workloads has expanded significantly. These factors have led to framework specialization, with each framework customized for specific types of hardware and workloads. As a result, numerous implementations have emerged, which can be challenging to develop, use, and maintain effectively.

To address these challenges and leverage the existing diversity while avoiding drawbacks, a composable and modular architecture for a dataflow execution framework in heterogeneous systems may be implemented. This architecture can define unified interfaces for compute operators and data-transfer kernels, enabling interplay between communication and computation backends. The architecture may allow for multiple implementation variants even on the same hardware, corresponding to different algorithms tailored for various workloads.

In this disclosure, a distinction is made between implementation variants and backends. Implementation variants generally refer to different algorithms or methods for executing an operator on the same hardware platform. For example, an operator might have multiple implementation variants optimized for different data sizes, all running on a CPU. Backends, on the other hand, generally refer to implementation variants on different computing hardware. For instance, a CPU implementation and a GPU implementation of the same operator would be considered different backends. This distinction allows for fine-grained optimization, considering algorithmic variations and hardware-specific implementations.

In implementations, the proposed approach allows for composable reconfigurability, which refers to the ability to easily swap different implementation variants for operators in the dataflow graph without requiring changes to the overall graph structure. This property allows for flexible optimization and adaptation to different hardware configurations.

For example, as shown in FIG. 1, the implementation variant for the first operator a 102 can be changed from the first variant (a, i) 122 to the second variant (a, j) 124, the third variant (a, k) 126, or the fourth variant (a, l) 128 without altering the connections to other operators in the graph. This composability can extend to the nodes (operators) and the edges (data transfers) in the dataflow graph. By modifying the corresponding node or edge in the execution graph, the implementation variant or a data transfer method can be changed without affecting the rest of the structure. This flexibility allows the system to efficiently adapt to different hardware environments and optimization scenarios.

FIG. 2 illustrates an implementation of a distributed grouped aggregation dataflow graph 200 with data parallelism. As shown, the graph is executed across two machines: a first machine 202 and a second machine 204. Each machine includes four operators: a first local GroupBy operator 206a-b, a local data partitioning operator 208a-b, a distributed data exchange operator 210a-b, and a second local GroupBy operator 212a-b, which may (or may not) be arranged as shown. It should be appreciated that the number of machines and operators is non-limiting and may differ from that shown in dataflow graph 200.

This distributed dataflow configuration demonstrates how operators can represent or involve communication operations in a distributed setting. The first local GroupBy operator 206a-b and the local data partitioning operator 208a-b are examples of local operators that do not include communication between ranks. In contrast, the distributed data exchange operator 210a-b represents a distributed operator involving communication between ranks in the distributed setting.

The first machine 202 and the second machine 204 may represent separate computing devices in a distributed computing environment. Each machine can include one or more processors, memory, storage, and networking components to execute the distributed dataflow. The machines may be coupled via a network connection, allowing for data exchange and communication.

The dataflow graph 200 exemplifies a distributed dataflow, containing at least one distributed operator. The architecture allows for efficient processing of large datasets across multiple machines, leveraging data parallelism to improve overall performance and scalability.

In this configuration, both machines execute the same dataflow but with different portions of the input data—an input table can be divided between the first machine 202 and the second machine 204. For example, input table A and input table B represent different portions of the input data distributed across the two machines. This data distribution allows an optimizer to process large datasets efficiently. By dividing the input data between multiple machines, the system can leverage data parallelism, allowing each machine to work on a subset of the data concurrently. This approach can significantly reduce the overall processing time for large-scale data operations.

On each machine, the dataflow begins with the first local GroupBy operator 206a-b. The first local GroupBy operator 206a-b can perform various aggregation operations on the local data subset. These operations may include summing, averaging, counting, or other statistical computations based on specified grouping criteria. The operator may utilize different algorithms or implementation variants optimized for the specific hardware of each machine.

The output of the first local GroupBy operator 206a-b feeds into the local data partitioning operator 208a-b. The local data partitioning operator 208a-b can employ various strategies to divide the locally processed data for distribution. This may involve hash-based partitioning, range partitioning, or other methods suitable for the data characteristics and the subsequent distributed operation.

The distributed data exchange operator 210a-b exemplifies a distributed operator that involves communication between ranks in the distributed setting. This operator implements various communication patterns, with an all-gather-like operation being one example. Depending on the network infrastructure and performance requirements, this operator may utilize different communication libraries or protocols. This step ensures that each machine can access the necessary data from both sources, facilitating the distributed nature of the computation.

The second local GroupBy operator 212a-b performs the final aggregation step on the combined data from all machines. As it works on the complete dataset, this operator may employ more complex aggregation algorithms than the first GroupBy operator 206a-b. It can produce the final results of the distributed computation, which may be further processed or stored as needed.

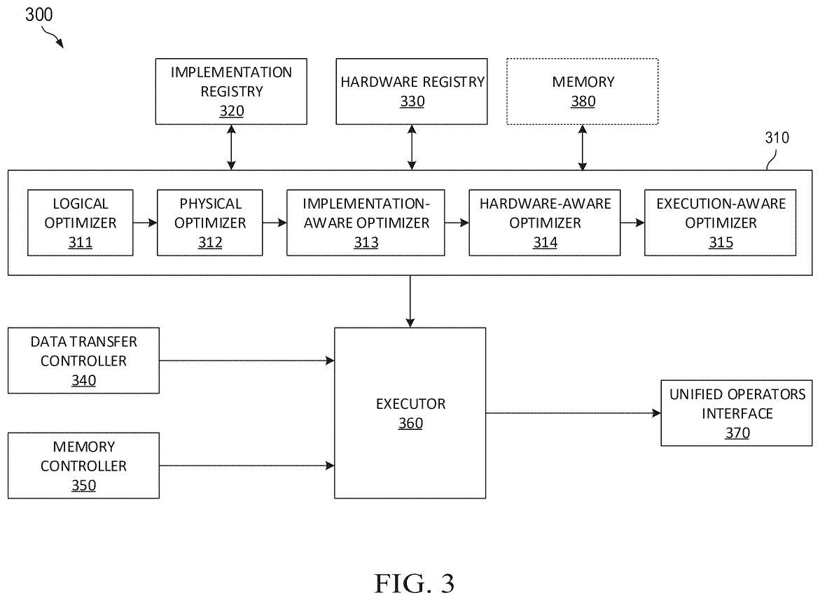

FIG. 3 illustrates a simplified block diagram of a system 300 for optimizing execution strategies in dataflow graphs. The system 300 comprises a multi-level optimizer circuit 310, an implementation registry 320, a hardware registry 330, a data transfer controller 340, a memory controller 350, an executor circuit 360, and a unified operators interface 370, which may (or may not) be arranged as shown.

System 300 receives the dataflow graphs from various sources (e.g., workflow managers, query engines, data processing frameworks). The various system components work together to determine optimal execution plans for dataflow graphs in heterogeneous computing environments. System 300 may include additional components not shown.

The multi-level optimizer circuit 310 includes a logical optimizer circuit 311, a physical optimizer circuit 312, an implementation-aware optimizer circuit 313, a hardware-aware optimizer circuit 314, and an execution-aware optimizer circuit 315, which may (or may not) be arranged as shown. The multi-level optimizer circuit 310 and its components can be implemented in various ways. For example, these components may be realized as software instructions executed on one or more general-purpose processors, dedicated hardware circuits, or a combination thereof. Multi-level optimizer circuit 310 may include additional components not shown.

In a software implementation, each optimizer component may correspond to a set of instructions stored in memory 380 and executed by a processor to perform the respective optimization tasks. Alternatively, each optimizer component may be embodied in a hardware implementation as a specialized circuit designed to perform specific optimization functions. System 300 also allows for hybrid implementations, where some components are software-based while others are hardware-based, providing flexibility to balance performance and adaptability based on specific deployment requirements. This flexible approach to implementation enables the system to efficiently handle various dataflow structures and hardware configurations, adapting to different computational environments as needed.

In implementations, logical optimizer circuit 311 performs hardware-agnostic optimizations. These optimizations can include, but are not limited to, predicate pushdown and join reordering. Predicate pushdown involves moving filtering operations closer to the data source, potentially reducing the amount of data processed in subsequent steps. Join reordering aims to optimize the sequence of join operations to minimize intermediate result sizes and improve overall query performance.

In implementations, physical optimizer circuit 312 handles standard lower-level optimizations that focus on improving the execution efficiency of specific operations. These optimizations may include index selection, determining the optimal build and probe sides of hash-joins, and implementing runtime hash-join filtering. Index selection involves choosing the most appropriate indexes to speed up data retrieval operations. The optimizer can determine which side of a hash-join should be used for building the hash table and which for probing based on data characteristics and system resources. Runtime hash-join filtering can enhance performance by reducing the data processed during join operations.

In implementations, implementation-aware optimizer circuit 313 examines all available implementations or algorithms for each operator in the dataflow graph after the logical operations have been fixed. It decides which implementation variant to use for each operator based on a comprehensive analysis of available options and performance metrics. Implementation-aware optimizer circuit 313 can consider factors such as the specific characteristics of each implementation, their suitability for different data sizes and distributions, and their performance on various hardware configurations.

The hardware-aware optimizer circuit 314 can make decisions tailored to the available hardware resources and their characteristics. It can determine hardware-specific parameters such as the optimal number of CPU threads for executing a particular operator or the appropriate number of GPU streams to employ. Additionally, it can consider the execution policy for each operator, deciding between options such as blocking or asynchronous execution. The hardware-aware optimizer circuit 314 can also calculate the optimal batch size for each operator based on the device it will run on, considering factors like memory capacity and processing power.

In implementations, execution-aware optimizer circuit 315 considers the dynamic state of the execution environment before producing the final execution plans. Execution-aware optimizer circuit 315 can consider real-time factors such as the number of concurrent tasks already running on the system, the amount of available memory at the time of execution, current hardware utilization levels, and other relevant runtime parameters. By incorporating up-to-the-moment information, execution-aware optimizer circuit 315 can adapt the execution plan to the current system state, potentially avoiding resource conflicts, minimizing wait times, and maximizing overall system efficiency.

While the current implementation primarily focuses on static optimization, the execution-aware optimizer circuit 315 provides a framework for future enhancements that could include dynamic adjustments to the execution strategy based on real-time system conditions. This could allow for more adaptive and responsive optimization in complex, changing computational environments.

The multi-level approach allows the multi-level optimizer circuit 310 to consider various aspects of the dataflow graph, from logical structure to specific hardware capabilities and runtime conditions, enabling comprehensive optimization strategies for local and distributed dataflows.

The multi-level optimizer circuit 310 can adapt its decisions based on the information provided by the implementation and hardware registries, allowing for flexible and efficient execution in heterogeneous computing environments. The optimized execution plans are fed as a composable reconfigurable execution plan to the executor circuit 360.

In implementations, the implementation registry 320 and hardware registry 330 are structured as data storage units, such as register banks or database tables, that maintain organized records of available implementations and hardware resources, allowing for efficient lookup and management of this information during the optimization process.

The implementation registry 320 is configured to store information about available implementations and implementation variants for each operator in the dataflow graph. It can include details about operator implementations, their traits, and mechanisms for registry management. The implementation registry 320 can be extended to make the multi-level optimizer circuit 310 aware of additional implementation variants. This extensibility allows the system to adapt to new algorithms or optimized implementations as they become available.

The hardware registry 330 is configured to store details about available computing and data transfer hardware. It contains information about computing hardware (such as CPUs, GPUs, and FPGAs) and data transfer hardware (like interconnects and links), along with their respective traits and management mechanisms. Like the implementation registry 320, the hardware registry 330 can be extended to inform the multi-level optimizer circuit 310 of new hardware components.

The data transfer controller 340 is configured to handle data movement between different devices using various communication backends. It enables uniform data transfers between different devices using different links/communication backends. The data transfer controller 340 can include a unified data transfer interface, a data serializer, a data deserializer, a data partitioner, and data transfer kernels. These components work together to manage the complexities of data movement in heterogeneous environments.

The data transfer kernels may support various communication libraries such as NVIDIA Collective Communications Library (NCCL), ROCm Communication Collectives Library (RCCL), Alveo Collective Communication Library (ACCL), Unified Communication Collective (UCC), Unified Communication X (UCX), and Message Passing Interface (MPI), allowing for efficient data exchange across different hardware platforms and network configurations.

The memory controller 350 is configured to manage memory across the system's different hardware components. It can optimize memory allocation, deallocation, and access patterns across heterogeneous computing resources. The memory controller 350 may implement strategies for efficient memory utilization, such as memory pooling, caching, and pre-fetching, to reduce latency and improve overall system performance. It can also coordinate with the data transfer controller 340 to optimize data placement and movement, ensuring that data is available where and when it is needed for computation.

The data transfer controller 340 and memory controller 350 can be implemented as control circuits, which can be dedicated hardware controllers or software modules executed by a general-purpose processor that, combined with memory 380, performs the respective data transfer and memory management functions of these controllers.

The executor circuit 360 is configured to receive a list of queries and generate a schedule for execution, which can be fed to the unified operators interface 370 for hybrid or parallel execution. It can act as a central coordination point, translating the optimized execution plans of the multi-level optimizer circuit 310 into actionable tasks. The executor circuit 360 may implement various scheduling algorithms to efficiently distribute workloads across available resources, such as data locality, load balancing, and resource availability. It can also handle task dependencies, ensuring that operations are executed in the correct order while maximizing parallelism where possible.

The executor circuit 360 can be implemented as a scheduling and execution management circuit, which can be a dedicated hardware component or a software module running on a general-purpose processor that, in conjunction with memory 380, coordinates the execution of optimized dataflow graphs based on the decisions made by the multi-level optimizer circuit 310.

The unified operators interface 370 is configured as a standardized interface for operators and implementations, facilitating interoperability between different system components. It includes various backends, such as CPU, GPU, and FPGA backends, as well as operator pools from both third-party and native engines. In implementations, the unified operators interface 370 contains all the available implementations specified in the implementation registry 320.

This interface allows for composable design and interplay between different implementations and configurations, enabling the system to leverage a wide range of specialized algorithms and hardware-specific optimizations.

The operator set can be extended by adding new operators and incorporating new implementation variants of existing operators, providing flexibility to adapt to evolving computational needs and hardware capabilities.

Through this unified interface, the system can seamlessly switch between different implementation variants based on the decisions made by the multi-level optimizer circuit 310, optimizing performance across heterogeneous computing environments for both local and distributed dataflows.

System 300 aims to provide a flexible and efficient solution for dataflow processing in heterogeneous computing environments. By considering various factors such as hardware capabilities, implementation variants, and dynamic execution states, the system can adapt to different scenarios and optimize performance across a wide range of dataflow structures and configurations.

The robust nature of the proposed architecture can open up new optimization dimensions. The optimizer may consider the available hardware and implementation variants when producing optimal hybrid execution plans. The design can incorporate implementation-aware, hardware-aware, and execution-aware optimizers, which may consider communication and computation costs.

The modular architecture can offer usability advantages by allowing users to switch between different implementations or backends easily. In practice, the hybrid execution plans produced by such an optimizer may be multiple factors faster to execute than non-hybrid plans. Accordingly, the performance improvement can justify the theoretical advantages of the optimizer and the framework's architecture.

The proposed architecture can handle local and distributed dataflows, with the latter involving communication operations between ranks in a distributed setting. The system 300 can adapt to different dataflow structures and hardware configurations, providing a flexible approach for optimizing data processing tasks in heterogeneous computing environments.

The system 300 can efficiently handle local and distributed dataflows. In local dataflows, all operations can be performed within a single machine or computational unit, leveraging various optimization strategies and hardware-specific implementations to maximize performance. The architecture can incorporate additional considerations for distributed dataflows to manage data distribution and inter-node communication complexities.

In distributed settings, the architecture supports dataflows that contain distributed operators, which can involve communication operations between ranks. The multi-level optimizer circuit 310 can optimize the distributed operators, considering the costs and benefits of data movement across the network. The data transfer controller 340 can manage the distributed operations, utilizing appropriate communication libraries to facilitate efficient data exchange between nodes.

The implementation-aware optimizer circuit 313 and hardware-aware optimizer circuit 314 can work in concert to select the most suitable implementation variants and hardware configurations for local and distributed operations, ensuring that the system can adapt to the specific requirements of each dataflow type. This flexible approach allows the architecture to scale from single-machine computations to complex, multi-node distributed processing tasks, maintaining efficiency and performance across various scenarios.

It should be noted that system 300 can handle multiple input dataflows simultaneously. While the discussion often focuses on optimizing a single dataflow graph for clarity, the multi-level optimizer circuit 310 can process and optimize multiple dataflow graphs concurrently. This allows the system to efficiently allocate resources and find optimal execution strategies when multiple data processing tasks are submitted simultaneously. The optimizer can consider the available hardware resources and implementation variants to determine the best overall execution plan for all input dataflows, considering potential resource conflicts and optimizing for overall system performance.

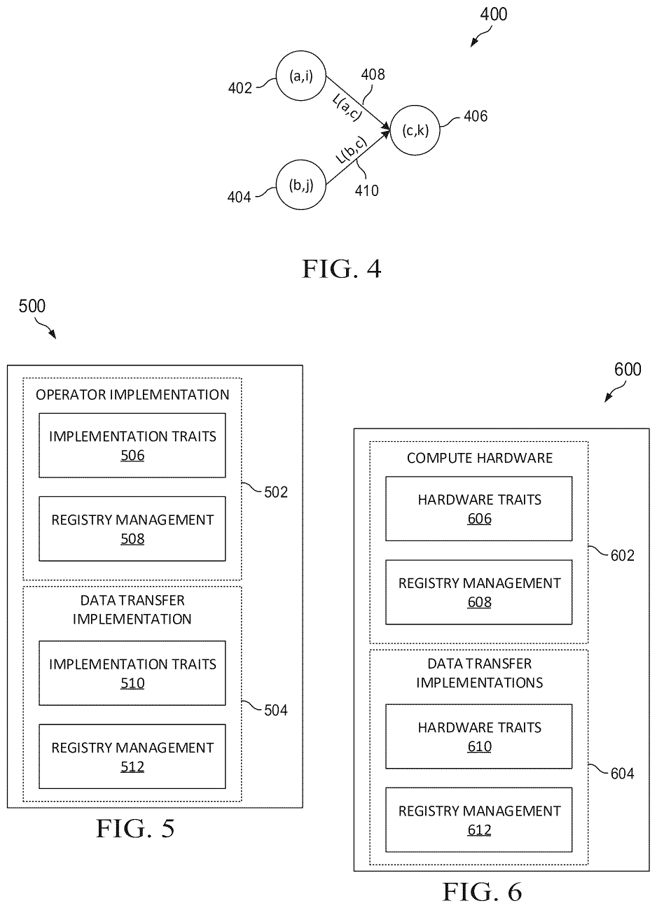

FIG. 4 illustrates an implementation of an execution graph 400 demonstrating modular reconfigurability in dataflow optimization. The execution graph comprises three nodes: a first variant (a, i) 402, a second variant (b, j) 404, and a third variant (c, k) 406, which may (or may not) be arranged as shown. Two directed edges connect the variants: a first edge L(a, c) 408 coupling the first variant (a, i) 402 to the third variant (c, k) 406, and a second edge L(b, c) 410 coupling the second variant (b, j) 404 to the third variant (c, k) 406. It should be noted that the number of variants and directed edges is non-limiting and may differ from that shown in the execution graph 400.

The letters i, j, and k in each node represent the selected implementation variants of the first operator a 102, the second operator b 104, and the third operator c 106, respectively. For example, the first variant (a, i) 402 represents the first operator a 102 using the implementation variant i, which may be optimized for a particular hardware type or data characteristic.

Execution graph 400 showcases how implementation variants can be selected for each operator in a modularly reconfigurable manner. System 300 can change the implementation variant for any operator by modifying the corresponding variant in the execution graph. For example, if a different implementation variant for the first operator a 102 becomes optimal based on available hardware resources and runtime conditions, system 300 can update the variant for the first operator a 102 without affecting the rest of the execution graph.

The first edge L(a, c) 408 and the second edge L(b, c) 410 represent data transfer and data transformation operations between the coupled operators. The directed edges can encapsulate the cost and methods of moving and adapting data between different implementation variants or hardware backends. System 300 can modify the directed edges independently to optimize data movement, for example, by choosing a more efficient serialization method or a different communication protocol based on the network conditions.

The modular reconfigurability of the execution graph 400 can extend to more complex graph manipulations. In implementations, system 300 can perform a directed acyclic graph (DAG) manipulation, such as inserting new nodes for additional processing steps, removing edges to eliminate unnecessary data transfers, or merging nodes to combine operations for improved efficiency.

For example, if system 300 detects that the first operator a 102 and the second operator b 104 frequently operate on the same data, it can merge the first variant (a, i) 402 and the second variant (b, j) 404 into a single variant that performs both operations, potentially reducing data movement and improving overall performance.

The flexible architecture enables dynamic adaptation of the execution plan in response to changing conditions, such as varying data sizes, shifts in hardware availability, or evolving optimization goals. The ability to make localized changes to operators, variants, nodes, and edges allows system 300 to continuously refine the execution strategy without necessitating a complete reconfiguration of the entire execution graph. The approach can be advantageous in heterogeneous computing environments, where the optimal execution strategy may vary significantly depending on the specific combination of hardware resources and data characteristics encountered during runtime.

FIG. 5 illustrates a block diagram of an example implementation registry 500, which can be implemented as the implementation registry 320 in system 300. The implementation registry 500 includes an operator implementation registry 502 and a data transfer implementation registry 504, which may or may not) be arranged as shown. Each registry includes implementation traits registry 506 and 510 and registry management 508 and 512. In some implementations, implementation registry 500 may include additional components not shown.

In implementations, the implementation registry 500 functions as a comprehensive data storage system, which can be realized as a set of interconnected register banks or a structured database. It can be a central repository for information about operator and data transfer implementations. The implementation registry 500 can be organized into distinct but interrelated components, each potentially corresponding to a separate lookup table within the larger data structure.

The operator implementation registry 502 and data transfer implementation registry 504 can form the primary divisions, with each further subdivided into implementation traits registries 506, 510 and registry management 508, 512. The subdivisions allow for efficient storage, retrieval, and management of implementation-specific information, enabling the multi-level optimizer to make informed decisions about execution strategies.

Operator implementation registry 502 contains information about multiple implementation variants for each operator. An operator may have implementation variants for various computing hardware types, such as CPUs, GPUs, FPGAs, and other computational devices. Further, on the same computing hardware, multiple implementation variants can correspond to different algorithms used in an implementation.

The implementation trait registry 506 within the operator implementation registry 502 stores all the implementation characteristics relevant to the multi-level optimizer circuit 310. The registry management 508 provides a mechanism to register or deregister an implementation, allowing for the extension of the implementation registry 500.

Data transfer implementation registry 504 similarly contains information about multiple implementation variants of data transfer kernels. These variants can be designed for various underlying links or interconnects used in the system. Additionally, multiple implementation variants can be for the same underlying interconnect, utilizing, for example, different communication algorithms. The implementation trait registry 510 within the data transfer implementation registry 504 can store the relevant characteristics of these transfer implementations. The registry management 512 provides functionality to manage the registration and deregistration of data transfer implementations.

The structure of the implementation registry 500 allows the system to maintain a comprehensive catalog of available implementation options for operators and data transfer operations. The multi-level optimizer circuit 310 can use the information stored in the implementation registry 500 to make informed decisions about which implementation variants to choose based on the specific requirements of the dataflow graph, the available hardware resources, and the current system state. Registering and deregistering implementations provide flexibility and extensibility, allowing the system to adapt to new algorithms, hardware, or optimization strategies as they become available.

FIG. 6 illustrates a block diagram of an example hardware registry 600, which can be implemented as the hardware registry 330 in system 300. The hardware registry 600 includes the computing hardware registry 602 and the data transfer hardware registry 604. Each registry includes hardware traits registry 606 and 610 and registry management 608 and 612. In some implementations, hardware registry 600 may include additional components not shown.

In implementations, the hardware registry 600 is structured as a comprehensive data storage system, implementable as a set of interconnected register banks or a structured database. It can be a centralized repository for information about available computing and data transfer hardware resources. The hardware registry 60 can be organized into distinct but interrelated components, each potentially corresponding to a separate lookup table within the larger data structure.

The computing hardware registry 602 and data transfer hardware registry 604 can form the primary divisions, with each further subdivided into hardware traits registries 606, 610, and registry management 608, 612. This organization allows for efficient storage, retrieval, and management of hardware-specific information, enabling the multi-level optimizer to make informed decisions about resource allocation and execution strategies based on the available hardware capabilities.

Computing hardware registry 602 contains information about the computing hardware used for operator execution. This can include multiple types of CPUs, GPUs, FPGAs, and other computational devices. The hardware traits registry 606 within the computing hardware registry 602 can store all the hardware-related information necessary for the multi-level optimizer circuit 310 to make informed decisions about resource allocation and execution strategies. The registry management 608 provides a mechanism to add or remove hardware information, allowing the system to adapt to changes in the available computational resources.

Data transfer hardware registry 604 includes information about all the hardware relevant for data transfer, such as interconnects and different links. Similar to the computing hardware registry 602, the hardware traits registry 610 within the data transfer hardware registry 604 stores the characteristics and capabilities of the transfer hardware options. The registry management 612 allows for adding or removing data transfer hardware information, enabling the system to stay up-to-date with the current network infrastructure.

The structure of the hardware registry 600 enables the system to maintain a comprehensive inventory of available hardware resources for computation and data transfer. The multi-level optimizer circuit 310 can utilize this information to make efficient decisions about task allocation and data movement, considering each hardware component's specific capabilities and limitations. The ability to dynamically update the hardware registry 600 through the registry management allows the system to adapt to hardware changes, upgrades, or reconfigurations, ensuring that optimization decisions are always based on the most current hardware landscape.

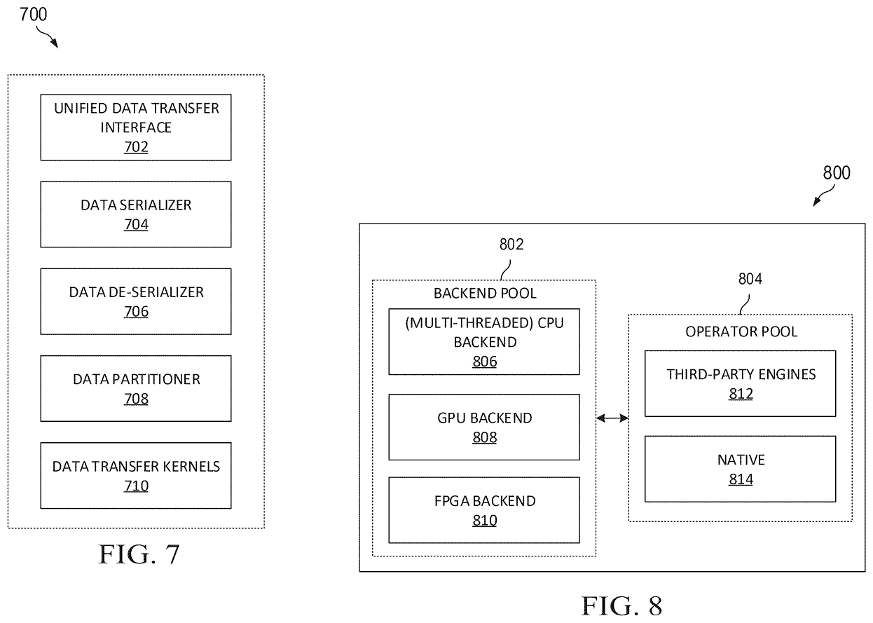

FIG. 7 illustrates a block diagram of an example data transfer controller 700, which can be implemented as the data transfer controller 340 in system 300. The data transfer controller 700 includes a unified data transfer interface 702, a data serializer circuit 704, a data de-serializer circuit 706, a data partitioner circuit 708, and data transfer kernels 710, which may (or may not) be arranged as shown. The data transfer controller 700 may include additional components not shown.

In implementations, the data transfer controller 700 is a central management system for coordinating and optimizing data movement within the heterogeneous computing environment. It can be implemented as a dedicated hardware controller or software instructions executed by a general-purpose processor. In the latter case, the instructions can be stored in memory and executed as needed. Whether implemented in hardware or software, the modular structure allows the data transfer controller to adapt to various communication protocols and hardware configurations, ensuring optimal data movement across different devices and interconnects in the system.

The unified data transfer interface 702 enables easy switching between different underlying interconnects or data exchange implementation variants. This interface provides a standardized way to interact with various data transfer mechanisms, allowing the system to adapt to different hardware configurations and communication protocols without requiring significant changes to the higher-level components.

The data serializer circuit 704 and data de-serializer circuit 706 work in tandem to manage the conversion of data structures for efficient transfer and subsequent reconstruction. The data serializer circuit 704 transforms complex data structures into a format suitable for transmission across different hardware and network configurations. Conversely, the data de-serializer circuit 706 reconstructs the original data structures from the received serialized format, ensuring data integrity throughout the transfer process.

The data partitioner circuit 708 divides data into appropriate chunks for efficient transfer and processing. It can implement various partitioning strategies based on the data's nature, the available hardware's characteristics, and the receiving operators' requirements.

The data transfer kernels 710 represent the actual implementations of data transfer operations. These kernels can utilize different communication libraries such as Message Passing Interface (MPI), Unified Communication X (UCX), Unified Communication Collective (UCC), NVIDIA Collective Communications Library (NCCL), ROCm Communication Collectives Library (RCCL), and Alveo Collective Communication Library (ACCL), depending on the underlying interconnect. Multiple data transfer kernel implementation variants may exist for the same interconnect, corresponding to different implementation variants of the communication routines.

FIG. 8 illustrates a block diagram of an example unified operators interface 800, which can be implemented as the unified operators interface 370 in system 300. Unified operators interface 800 comprises a backend pool 802 and an operator pool 804, which may (or may not) be arranged as shown. The backend pool 802 includes a (multi-threaded) CPU backend 806, a GPU backend 808, and an FPGA backend 810. The operator pool 804 contains third-party engines 812 and native implementations 814. Unified operators interface 800 may include additional components not shown.

The unified operators interface 800 exposes available operators through a standardized interface, defining the semantics and syntax of operators. The unified approach allows for composable design, enabling interplay between different implementations and configurations. The interface facilitates the integration of various hardware backends and software implementations, providing a flexible framework for optimizing dataflow execution.

The backend pool 802 represents the hardware-specific implementations of operators. For example, the (multi-threaded) CPU backend 806 can utilize multiple CPU cores for parallel processing of operators. The GPU backend 808 leverages the massive parallelism of graphics processing units for computationally intensive tasks. The FPGA backend 810 allows for custom hardware implementations of operators, potentially offering high performance for specific algorithms. Although three backend pool varieties are shown in FIG. 8, the backend pool may contain other types or include additional varieties.

The operator pool 804 contains the software implementations of operators. The third-party engines 812 may include external libraries or frameworks that provide specialized operator implementations. The native implementations 814 can represent in-house developed operators optimized for the system's specific requirements.

For each operator, the unified operators interface 800 may provide multiple implementation variants. These variants can be optimized for different scenarios, data characteristics, or performance metrics. Even on the same computing hardware, multiple implementation variants can address various algorithmic approaches or optimization strategies.

This architecture allows the system to select the most appropriate implementation for each operator based on the current hardware configuration, data characteristics, and optimization goals. The flexibility provided by the unified operators interface 800 enables the system to adapt to diverse computing environments and workload requirements, potentially improving overall performance and efficiency in dataflow execution.

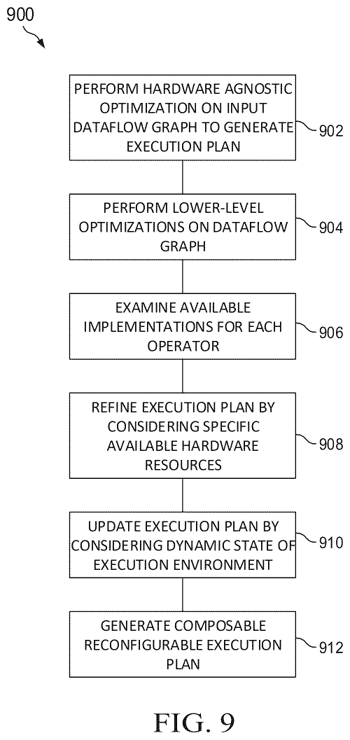

FIG. 9 illustrates a flowchart of an implementation method 900 for operating the multi-level optimizer circuit 310. The method 900 involves the operation of several components within the multi-level optimizer circuit 310, including a logical optimizer circuit 311, a physical optimizer circuit 312, an implementation-aware optimizer circuit 313, a hardware-aware optimizer circuit 314, and an execution-aware optimizer circuit 315. The method 900 also utilizes information from the implementation registry 320, hardware registry 330, and cost modeling data to generate a composable reconfigurable execution plan from an input dataflow graph.

At step 902, the logical optimizer circuit 311 performs hardware-agnostic optimizations on the input dataflow graph. The logical optimizer circuit 311 may apply techniques such as predicate pushdown and join reordering to improve the overall structure of the dataflow graph without considering specific hardware constraints. The optimized graph is then passed to the physical optimizer circuit 312.

At step 904, the physical optimizer circuit 312 focuses on lower-level optimizations that enhance the execution efficiency of specific operations within the dataflow graph. This step may involve index selection, determining optimal build and probe sides for hash-joins, and implementing runtime hash-join filtering. Based on these considerations, the physical optimizer circuit 312 refines the graph structure and forwards the result to the implementation-aware optimizer circuit 313.

At step 906, the implementation-aware optimizer circuit 313 examines all available implementations for each operator in the dataflow graph. This component accesses the implementation registry 320 to gather information about various implementation options. The implementation-aware optimizer circuit 313 evaluates each option based on factors such as performance characteristics and suitability for different data sizes and distributions. It selects the most appropriate implementation variant for each operator in the graph.

At step 908, the hardware-aware optimizer circuit 314 refines the execution plan by considering the specific hardware resources available. This component consults the hardware registry 330 to obtain information about the system's computing and data transfer hardware. The hardware-aware optimizer circuit 314 makes decisions such as determining the optimal number of CPU threads or GPU streams for each operator and calculates appropriate batch sizes based on the target device's capabilities.

At step 910, in the final optimization stage, the execution-aware optimizer circuit 315 considers the dynamic state of the execution environment. This component may consider factors such as current system load, available memory, and hardware utilization levels. The execution-aware optimizer circuit 315 can adapt the execution plan to accommodate real-time conditions, potentially avoiding resource conflicts and maximizing overall system efficiency.

At step 912, after all optimization stages are complete, the multi-level optimizer circuit 310 generates a composable reconfigurable execution plan. This plan incorporates the decisions made by each optimizer component. It provides a comprehensive strategy for executing the dataflow graph in the most efficient manner possible, given the available resources and current system state.

It is noted that all steps outlined in the flow chart of method 900 are not necessarily required and can be optional. Further, changes to the arrangement of the steps, removal of one or more steps and path connections, and addition of steps and path connections are similarly contemplated.

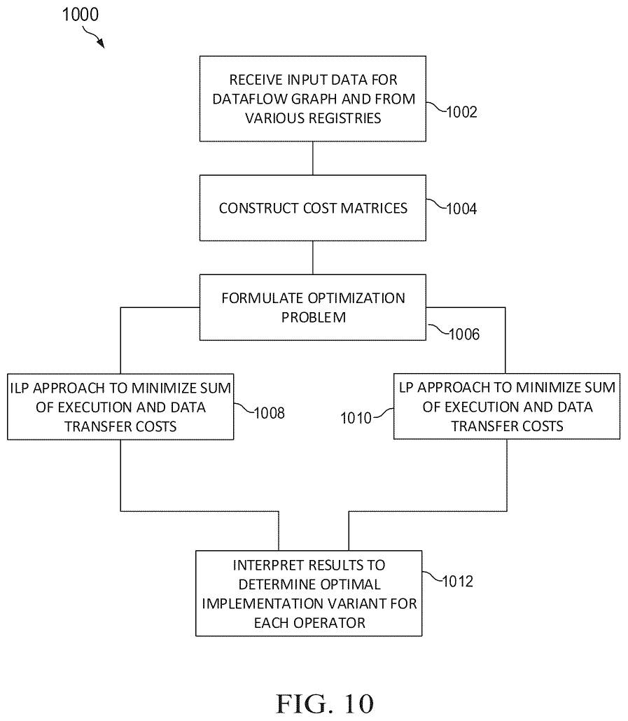

FIG. 10 illustrates a flowchart of an implementation method 1000 for operating the implementation-aware optimizer circuit 313. Method 1000 includes processing a dataflow graph G=(V, E), where V represents the set of operators and E represents the set of edges between operators. The implementation-aware optimizer circuit 313 utilizes information from the implementation registry 320 and the hardware registry 330 to determine the optimal execution strategy for the given dataflow graph.

At step 1002, the implementation-aware optimizer circuit 313 receives the dataflow graph G=(V, E) as input. It retrieves information about available implementation variants (e.g., B(a), where a is the operator) for each operator (i.e., a∈V), from the implementation registry 320. Additionally, it obtains the set of data transfer and data transformation implementation variants (e.g., L(a, b), where a and b are the operators) between the operators (e.g., a, b∈V) from the hardware registry 330.

At step 1004, two cost matrices are constructed: comp( ) and comm( ). It is helpful to illustrate the matrices using an example for the first operator a 102 and the second operator b 104. In this example, the comp(a, i) matrix represents the cost of using implementation variant i∈B(a) for executing the first operator a∈V.

It should be noted that the cost model encapsulated in these matrices is comprehensive. For example, the computation cost matrix comp(a, i) represents the total cost of executing the first operator a 102 using implementation variant i, assuming the data is already present on the target device. This cost includes not only the pure computation time, but also associated costs such as data fetching from local memory, memory access times, and any other overhead directly related to executing the operator with that specific implementation.

In this example, the comm( ) matrix, ∀(a, b)∈E; ∀l∈L(a, b), comm(a, b, i, j, l), represents the cost of data transformation and data transfer when the first operator a∈V uses implementation variant i∈B(a), the second operator b∈V uses implementation variant j∈B(b), and the data transfer and transformation kernel uses implementation variant l∈L(a, b).

Similarly, the communication cost matrix comm(a, b, i, j, l) represents the total cost of data transfer and any necessary data transformations between operators, including all overheads associated with moving data between different memory spaces or devices.

The goal is to have a cost model that accurately reflects the real-world performance characteristics of each implementation variant and data transfer operation, allowing the optimizer to make informed decisions about the optimal execution strategy. The specific details of how these costs are measured or estimated are not part of the current disclosure. They can be provided by the user or derived from historical performance data within the dataflow engine.

At step 1006, an optimization problem is formulated to minimize the overall cost function, which can be expressed as Cost=f(comp, comm). This function accounts for the computational cost and the data transformation and data movement cost.

At this point, method 1000 can proceed in one of two ways, depending on the characteristics of the dataflow graph and the available backends. The first approach (i.e., step 1008) involves solving an Integer Linear Program (ILP), while the second approach (i.e., step 1010) uses a Linear Program (LP) under certain conditions.

At step 1008, in the ILP approach, the communication backend (e.g., L(a, b)) is assumed to be fixed for all operators and is not part of the optimization. It is also assumed that the set of available operator backends (e.g., B(a)) is the same for all operators, denoted simply as B.

Based on these assumptions, an optimal execution plan can be generated by defining a binary variable (e.g., T(a, i)) indicating whether the operator is using a particular backend and a cost variable (e.g., C(a, i, j)) to represent the data data transfer cost between operators.

For example, if the first operator a is using the backend i: ∀a∈V, ∀i∈B:T(a, i)=1, otherwise: ∀a∈V, ∀i∈B:T(a, i)=0. Further, for each edge (a, b)∈E and for all i, j∈B, C(a, i, j)=T(a, i)+T(b, j)−1.

The ILP can be defined as:

$$min {\sum }_{a ∈ V , i ∈ B} T ( a , i ) \cdot q ( a , i ) + {\sum }_{a ∈ V , i , j ∈ B} C ( a , i , j ) \cdot q ( a , i , j ) ,$$

where q(a, i) is the cost of executing the first operator a 102 using the backend i and q(a, i, j) is the cost of data transfer from backend i to backend j for the input data of the first operator a 102.

The ILP equation is subject to:

$$∀ a ∈ V : {\sum }_{i ∈ B} T ( a , i ) \geq 1 , T ( a , i ) ∈ \vert 0 , 1 \vert and$$

$$∀ i , j ∈ B , ∀ ( a , b ) ∈ E : C ( a , i , j ) \geq T ( a , i ) + T ( b , j ) - 1 , C ( a , i , j ) ∈ \vert 0 , 1 \vert .$$

Accordingly, the ILP is formulated to minimize the sum of execution costs and data transfer costs, subject to constraints ensuring that each operator uses exactly one backend and that data transfer costs are correctly accounted for.

Alternatively, at step 1010, the integrality constraints are relaxed and a linear problem is solved. In certain cases, the integrality constraints of the ILP can be relaxed, leading to a simpler linear program that can be solved more efficiently. The relaxation is possible when the constraint matrix corresponding to the ILP constraints is a Totally Unimodular Matrix. One specific scenario occurs when the dataflow graph is a tree and there are at most two backends for each operator. In this case, the system can solve the optimization problem using LP techniques, generally faster than ILPs. It's important to note that while this tree structure with two backends per operator guarantees the ability to use LP, there can be other scenarios where LP is applicable.

The LP formulation maintains the same objective function as the ILP but relaxes the binary constraints on the binary variable (e.g., T (a, i)) and the cost variable (e.g., C(a, i, j)) to allow for real values between 0 and 1.

The LP can be defined as:

$$min {\sum }_{a ∈ V , i ∈ B} T ( a , i ) \cdot q ( a , i ) + {\sum }_{a ∈ V , i , j ∈ B} C ( a , i , j ) \cdot q ( a , i , j )$$

and subject to:

$$∀ a ∈ V : {\sum }_{i ∈ B} T ( a , i ) \geq 1 , 0 \leq T ( a , i ) \leq 1 and$$

$$∀ i , j ∈ B , ∀ ( a , b ) ∈ E : C ( a , i , j ) \geq T ( a , i ) + T ( b , j ) - 1 , 0 \leq C ( a , i , j ) \leq 1.$$

At step 1012, after solving either the ILP or LP, the results are interpreted to determine the optimal implementation variant for each operator in the dataflow graph. An optimized execution plan is generated based on these results, which is passed to the next stage of the multi-level optimizer circuit 310 for further refinement or execution.

It is noted that all steps outlined in the flow chart of method 1000 are not necessarily required and can be optional. Further, changes to the arrangement of the steps, removal of one or more steps and path connections, and addition of steps and path connections are similarly contemplated.

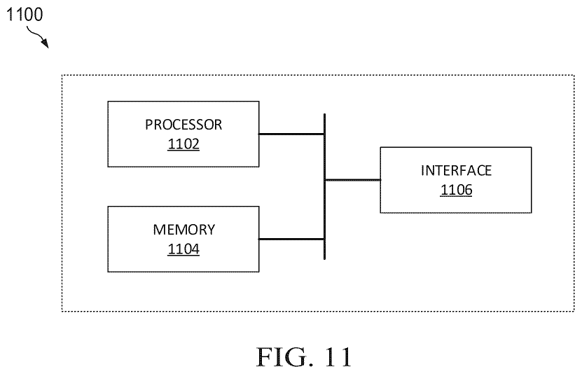

FIG. 11 illustrates a block diagram of an example computing device 1100, according to certain implementations. The implementations described herein for the system 300 can be implemented using the computing device 1100. Computing device 1100 includes a processor 1102, a memory 1104, and an interface 1106, which may (or may not) be arranged as shown. Computing device 1100 may include additional components that are not shown. For example, computing device 1100 may include a power supply to provide power to the computing device 1100.

Computing device 1100 can be, for example, a server (e.g., a blade-server in a blade-server chassis, a rack server in a rack, etc.), a desktop computer, a mobile device (e.g., laptop computer, smartphone, personal digital assistant, tablet computer, automobile computing system, or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, or a digital sensor.

In implementations, any or all of the aforementioned can be combined to create a system of such devices or partitioned into separate logical devices, collectively called computing device 1100. Other types of computing devices may be used without departing from the scope of implementations described herein.

In an implementation, processor 1102 is an integrated circuit, a single-core processor, a microcontroller, or a multi-core processor for processing instructions. Processor 1102 may be a general-purpose processor configured to execute program code included in software executing on computing device 1100. Processor 1102 may be a special-purpose processor where instructions are incorporated into the processor design. Although one processor 1102 is shown in FIG. 11, computing device 1100 may include any number of processors without departing from the scope of implementations disclosed herein. In implementations, the optimization program or set of instructions for optimization is executed by processor 1102.

In an implementation, memory 1104 is volatile memory, non-volatile memory, or both. In implementation, memory 1104 is a random-access memory (RAM), cache memory, persistent storage, a hard disk, an optical drive, flash memory, or the like. In an implementation, memory 1104 includes a data repository for storing dataflow graphs or registry information for any amount of data (e.g., information). In implementation, a data repository is any type of storage unit or device (e.g., a file system, database, collection of tables, RAM, or any other storage mechanism or medium) for storing data. Further, the data repository may include multiple different storage units or devices. The multiple storage units or devices may or may not be the same type or located at the exact physical location. In implementations, memory 1104 is configured to store instructions to be executed by processor 1102 to perform the methods disclosed herein.

In an implementation, interface 1106 is a touchscreen, a keyboard, a mouse, a microphone, a touchpad, an electronic pen, a motion sensor, or any other input device. In implementations, interface 1106 is a screen (e.g., a liquid crystal display (LCD), a plasma display, a touch screen, a cathode ray tube (CRT) monitor, a projector, or other display device), a printer, external storage, or any other output device. Interface 1106 may allow a user to interact with other devices, such as a device where the optimized dataflow graph is to be executed. In implementation, interface 1106 is an input and an output device. Interface 1106 may be locally or remotely coupled to the processor 1102 and memory 1104. Many different types of computing devices exist, and the aforementioned interface 1106 may take other forms.

In an implementation, interface 1106 may facilitate coupling computing device 1100 to a network (e.g., a local area network (LAN), a wide area network (WAN) such as the Internet, mobile network, or any other type of network) or another device, such as another computing device. Interface 1106 may perform or facilitate receipt or transmission of wired or wireless communications using wired or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 1G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

In an implementation, interface 1106 may include a Global Navigation Satellite System (GNSS) receiver or transceiver used to determine the location of computing device 1100 based on receiving one or more signals from one or more satellites associated with GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement. Therefore, the basic features here may easily be substituted for improved hardware or firmware arrangements as they are developed.

Methods described herein can be implemented using computer-executable instructions stored in memory 1104 or otherwise available from computer-readable media. Such instructions can include, for example, instructions and data that cause or otherwise configure processing devices, a computer, a special-purpose computer, or a processing device to perform a particular function or group of functions. Portions of computer resources used can be accessible over a network. The computer-executable instructions may be, for example, binaries and intermediate format instructions such as assembly language, firmware, source code, etc. Examples of computer-readable media that may be used to store instructions, information used, or information created during methods according to described examples include magnetic or optical disks, flash memory, USB devices provided with non-volatile memory, networked storage devices, or the like.

All or any portion of the components of computing device 1100 may be implemented in circuitry. For example, the components can include or can be implemented using electronic circuits or other electronic hardware, which can include one or more programmable electronic circuits (e.g., microprocessors, GPUs, DSPs, CPUs, or other suitable electronic circuits) or can include or be implemented using computer software, firmware, or any combination thereof, to perform the various operations described herein. In some aspects, computer-readable storage devices, mediums, and memories can include a cable or wireless signal containing a bit stream and the like.

The system described in the present disclosure offers several advantages in dataflow execution and optimization. The composable dataflow framework architecture enables interplay between different compute and data-transfer kernels in a modular manner. This architecture, coupled with the multi-level optimizer circuit 310, can produce optimal hybrid execution plans by considering available implementations for all compute and data-transfer kernels, as well as the properties of the underlying hardware.

The implementation-aware optimizer circuit 313 and hardware-aware optimizer circuit 314 work in tandem to improve performance for dataflow execution. These circuits generate optimal hybrid execution plans that take into account the specific characteristics of the available hardware and implementation variants. The resulting execution plans may lead to significant performance improvements compared to non-optimized approaches.

Energy efficiency can be incorporated into the optimization process. When energy consumption is factored into the optimization objective, the execution plans produced by the multi-level optimizer circuit 310 can result in reduced energy footprints. This feature may be particularly valuable in environments where energy conservation is a priority.

The composable nature of the framework architecture allows users to easily switch between different operators or data-transfer implementations. This flexibility enables rapid adaptation to changing requirements or the introduction of new, more efficient implementation variants. The unified operators interface 370 facilitates this interchangeability by providing a consistent interface for various implementation variants.

The system's ability to utilize various types of compute and data-transfer hardware offers enhanced code portability. The hardware registry 330 and implementation registry 320 allow the framework to adapt to different hardware configurations without requiring significant changes to the dataflow graph or application code. This portability can be especially beneficial in heterogeneous computing environments where hardware resources may vary.

By considering both computational costs and data movement costs, the optimization algorithms implemented in the implementation-aware optimizer circuit 313 can find execution plans that balance these factors effectively. This comprehensive approach to optimization can lead to more efficient use of available resources and improved overall system performance.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for executing dataflow graphs in heterogeneous computing environments, the computer system comprising:
a processor; and
a memory storing instructions that, when executed by the processor, cause the computer system to:
receive a dataflow graph representing a computational task,
access an implementation registry containing information on available operator implementations for different hardware types,
access a hardware registry containing information about available computing hardware,
access a cost model for executing the dataflow graph, wherein the cost model comprises execution costs for each operator on each available hardware type and data transfer costs between hardware types,
generate an execution configuration for the dataflow graph by evaluating multiple possible configurations using a cost function that considers execution costs and data transfer costs, wherein the generated execution configuration specifies an assignment of operators to hardware types and implementation variants, and
execute the computational task according to the generated execution configuration.

2. The computer system of claim 1, wherein the heterogeneous computing environment comprises at least two different types of computing hardware.

3. The computer system of claim 2, wherein the different types of computing hardware include a central processing unit (CPU), a graphics processing unit (GPU), a field-programmable gate array (FPGA), an application-specific integrated circuit (ASIC), a tensor processing unit (TPU), and a digital signal processor (DSP).

4. The computer system of claim 2, wherein each computing hardware has different performance characteristics for executing various computational operations and different data transfer infrastructure for moving data between the different types of computing hardware.

5. The computer system of claim 2, wherein the data transfer costs vary depending on the source and destination hardware types in the dataflow graph.

6. The computer system of claim 1, wherein generating the execution configuration comprises:
determining a set of available implementation variants for each operator in the dataflow graph;
formulating an Integer Linear Program (ILP) that minimizes a cost function considering execution costs and data transfer costs;
solving the ILP to determine an optimal assignment of operators to implementation variants; and
interpreting the ILP solution to generate the execution configuration.

7. The computer system of claim 1, wherein when the dataflow graph is a tree and each operator includes at most two available implementation variants, generating the execution configuration comprises:
formulating a Linear Program (LP) that minimizes a cost function considering execution costs and data transfer costs;
solving the LP to determine an optimal assignment of operators to implementation variants; and
interpreting the LP solution to generate the execution configuration.

8. The computer system of claim 1, further comprising a multi-level optimizer circuit configured to perform the generation of the execution configuration.

9. The computer system of claim 8, wherein the multi-level optimizer circuit comprises:
a logical optimizer circuit configured to perform hardware-agnostic optimizations on the dataflow graph;
a physical optimizer circuit configured to perform lower-level optimizations on the dataflow graph;
an implementation-aware optimizer circuit configured to select implementation variants for each operator;
a hardware-aware optimizer circuit configured to make hardware-specific decisions; and
an execution-aware optimizer circuit configured to consider dynamic execution state.

10. The computer system of claim 1, further comprising a data transfer controller configured to handle data movement between different devices using various communication backends.

11. The computer system of claim 10, wherein the data transfer controller comprises a unified data transfer interface, a data serializer circuit, a data de-serializer circuit, a data partitioner circuit, and data transfer kernels.

12. The computer system of claim 1, further comprising a unified operators interface configured to provide a standardized interface for operators and implementations.

13. The computer system of claim 12, wherein the unified operators interface comprises a backend pool and an operator pool.

14. The computer system of claim 13, wherein the backend pool includes implementations for at least one of a CPU backend, a GPU backend, and an FPGA backend.

15. A non-transitory computer-readable medium storing instructions for optimizing execution of dataflow graphs in heterogeneous computing environments, that, when executed by a processor, cause the processor to:
receive a dataflow graph representing a computational task;
access an implementation registry containing information on available operator implementations for different hardware types;
access a hardware registry containing information about available computing hardware;
access a cost model for executing the dataflow graph, wherein the cost model comprises execution costs for each operator on each available hardware type and data transfer costs between hardware types;
generate an execution configuration for the dataflow graph by evaluating multiple possible configurations using a cost function that considers execution costs and data transfer costs, wherein the generated execution configuration specifies an assignment of operators to hardware types and implementation variants; and
execute the computational task according to the generated execution configuration.

16. The non-transitory computer-readable medium of claim 15, wherein generating the execution configuration comprises:
formulating an Integer Linear Program (ILP) when the dataflow graph is not a tree or when there are more than two available implementation variants for at least one operator; and
formulating a Linear Program (LP) when the dataflow graph is a tree and there are at most two available implementation variants for each operator.

17. The non-transitory computer-readable medium of claim 15, wherein the instructions further cause the processor to:
perform hardware-agnostic optimizations on the dataflow graph;
perform lower-level optimizations on the dataflow graph;
select implementation variants for each operator;
make hardware-specific decisions; and
consider dynamic execution state.

18. The non-transitory computer-readable medium of claim 15, wherein the cost model encapsulates all costs associated with executing an operator, including data fetching and memory access, assuming the data is already on a target device.

19. A method for optimizing an execution of dataflow graphs in heterogeneous computing environments, the method comprising:
receiving a dataflow graph representing a computational task;
accessing an implementation registry containing information on available operator implementations for different hardware types;
accessing a hardware registry containing information about available computing hardware;
accessing a cost model for executing the dataflow graph, wherein the cost model comprises execution costs for each operator on each available hardware type and data transfer costs between hardware types;
generating an execution configuration for the dataflow graph by evaluating multiple possible configurations using a cost function that considers execution costs and data transfer costs, wherein the generated execution configuration specifies an assignment of operators to hardware types and implementation variants; and
executing the computational task according to the generated execution configuration.

20. The method of claim 19, further comprising:
handling data movement between different devices using various communication backends;
providing a standardized interface for operators and implementations; and
adapting the execution configuration in response to changes in available hardware resources or runtime conditions.
